(19) United States
(12) Patent Application Publication
(10) Pub. No.: US 2013/0179370 A1
(43) Pub. Date: Jul. 11, 2013

(54) REPRODUCING COPYRIGHTED WORKS WITH CONTENTS EXTRACTION

(71) Applicant: Toshiro FUJIMORI, Laguna Beach, CA (US)

(72) Inventor: Toshiro FUJIMORI, Laguna Beach, CA (US)

(73) Assignee: KONICA MINOLTA LABORATORY U.S.A., INC., San Mateo, CA (US)

(21) Appl. No.: 13/344,541

(22) Filed: Jan. 5, 2012

(51) Int. Cl. G06Q 30/06

(52) U.S. Cl. 705/400

(57) ABSTRACT

A method and program for reproducing copyrighted works with contents extraction to reduce copyright costs, including the steps of designating contents of a copyrighted work desired to be reproduced, extracting into a digital file portions of the copyrighted work containing the designated contents, editing the extracted portions if a format of the digital file allows for such editing to change a quantitative basis for calculating copyright fees for reproducing the desired contents of the copyrighted work, and calculating copyright fees for reproducing the desired contents of the copyrighted work based at least in part on the changed quantitative basis.

### BACKGROUND OF THE INVENTION

1. Field of the Invention

This invention relates to a method of reproducing copyrighted works, and in particular, it relates to reproducing copyrighted works with contents extraction to reduce costs for obtaining copyright permission or license for the works.

2. Description of Related Art

Customized reproduction of printed materials has become more popular with the development of modern printing technology. It is a trend to generate customized compilation of works in electronic or printed forms on a print-on-demand (POD) basis, which generally refers to production of commercial-quality printed and finished products such as books and booklets on a relatively small scale, typically by a professional print shop, at the request of customers.

As examples of customized reproduction of printed materials, an instructor or trainer in an organization may assemble a group of works and compile them into a booklet of training materials for the members of the organization, or a teacher or professor in an educational institution may assemble a group of works and compile them into a volume of course materials for his or her students. These groups of works to be compiled may include previously published papers or articles, images and graphics, etc., which are available in hard copies traditionally but now increasingly in electronic (digital) formats, such as in the portable document format (PDF), text (TXT) format, Tagged Imaged File Format (TIFF), Joint Photographic Experts Group (JPEG) format, etc. These works may include digital files in the teacher or instructor's own collection, e.g., stored in his or her own computer storage device such as a hard disc drive, or in a file folder assigned to him or her on a server of the institution or organization. These works may also include digital files in third parties' collections, e.g., stored in the third parties' servers and may be accessed via a computer network such as the Internet by using uniform resource locator (URL) links. Once the teacher or instructor selects the digital files, they can be assembled together to produce a compilation of works either in electronic form or printed copies.

Since most works are protected by copyrights nowadays, an often encountered issue in assembling and generating a compilation of works is the copyright concern. Many copyright permissions or license require a payment of fees. Traditionally copyright fees are often calculated on a per work basis. For example the copyright license fee for an article would be calculated based on the entirety of the article. However in recent years many copyright holders have adopted more sensitive approaches in calculating copyright fees. For example, if a user only needs to reproduce certain but not all of the pages of an article, some copyright holders will be willing to allow the user to reproduce only the pages that the user needs, and calculate the copyright fee based on the number of pages reproduced but not on the entirety of the article. Therefore it is desirable to provide a method to reproduce copyright works with only the contents needed in order to reduce the cost of paying for copyright permissions or licenses.

### SUMMARY

The present invention is directed to a method and related apparatus for reproducing copyrighted works in electronic or printed forms with only the contents needed in order to reduce the cost of paying for copyright permissions or licenses.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for reproducing copyrighted works with contents extraction to reduce copyright costs, comprising the steps of: designating contents of a copyrighted work desired to be reproduced; extracting into a digital file portions of the copyrighted work containing the designated contents; editing the extracted portions if a format of the digital file allows for such editing to change a quantitative basis for calculating copyright fees for reproducing the desired contents of the copyrighted work; and calculating copyright fees for reproducing the desired contents of the copyrighted work based at least in part on the changed quantitative basis.

In another aspect, one of the exemplary embodiments of the present invention further provides a computer program product that causes a data processing apparatus to perform the above methods. The computer program product includes a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a system environment in which embodiments of the present invention may be implemented.

FIGS. 2(a) through 2(d) illustrate a process of content extraction in reproducing copyrighted works according to an embodiment of the present invention.

FIG. 3 illustrates a computer-implemented method for reproducing copyrighted works in electronic or printed forms with contents extraction in order to reduce the copyright costs.

### DETAILED DESCRIPTION OF PREFERRED EMBODIMENTS

Embodiments of the present invention provides a method and related apparatus for reproducing copyrighted works in electronic or printed forms with contents extraction in order to reduce the fees to be paid for copyright licenses.

Practical scenarios of a need for reproducing copyrighted works in electronic or printed forms include, for example, an instructor or trainer of an organization desires to reproduce certain copyrighted articles to assemble a training booklet for the members of the organization, or a teacher or professor in an educational institution needs to reproduce certain copyrighted articles to assemble a course reader for the students. However, for such copyrighted articles, appropriate copyright licenses or clearance may need to be obtained first before the compilation may be produced, printed or distributed.

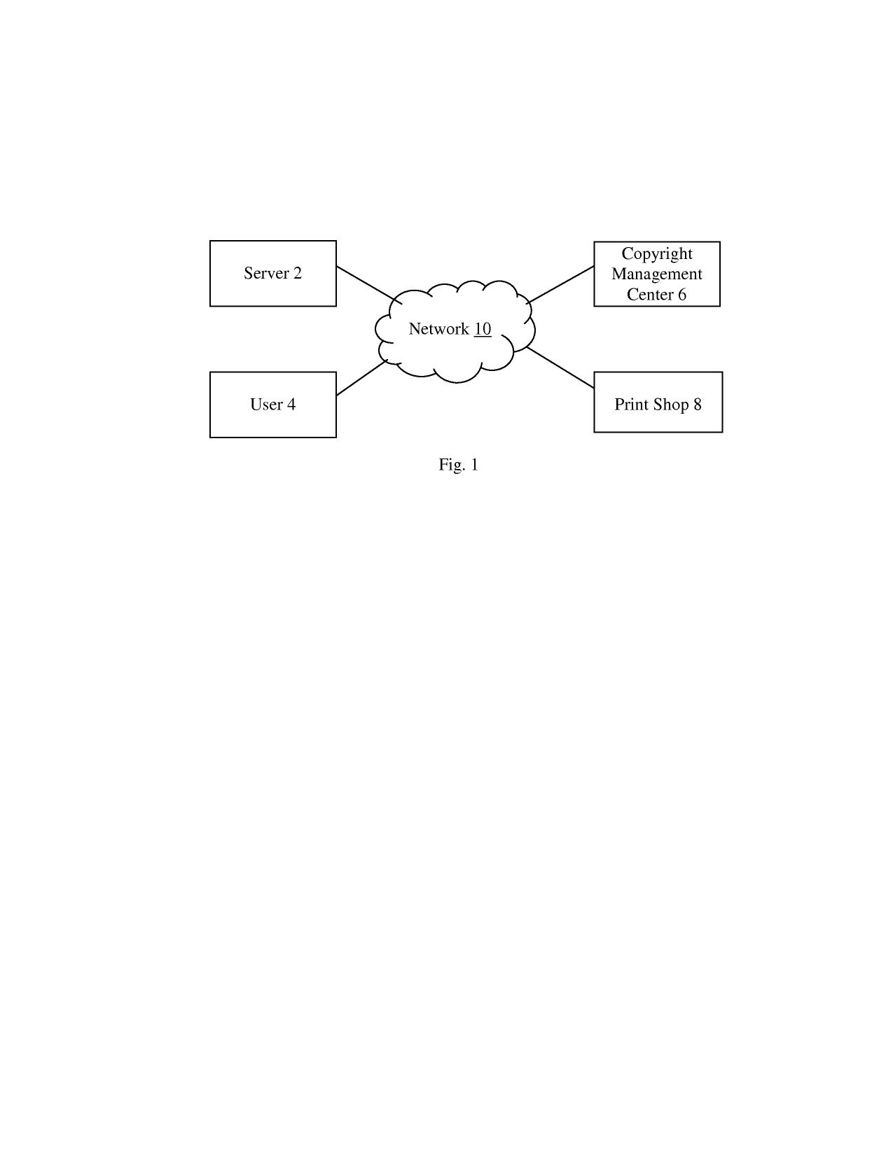

Referring to FIG. 1, there is schematically illustrated an exemplary system environment in which embodiments of the present invention may be implemented. The exemplary system includes a server 2, a client or user computer 4, one or more copyright management center servers 6, and a print shop server 8, connected via one or more computer network 10 such as the Internet or other communication links. A user or customer (such as an instructor or teacher, or a member of an organization or a student of an educational institution) uses the client computer 4 to interact with the server 2. The server 2 executes a computer program stored in a memory to perform processes according to embodiments of the present invention. The copyright management center 6 have servers and databases to store digital contents that may be obtained for use by the users, as well as copyright data or license information of such content, for calculating copyright fees, granting or clearing, or facilitates the granting or clearing, of copyright license for such works. The print shop 8 may be a professional print shop equipped with printers and various other image reproduction machines for producing printed products such as books, booklets, etc. The print shop server 8 manages the print jobs submitted to the print shop by the users or customers.

The server 2 generally provides an integrated service that allows a user to search and acquire copyrighted works from sources of such works, upload his or her own files, compile them into an electronic file, and submit the compiled file to a POD service such as print shop 8 to produce a printed product. The users may access the server 2 from their own computers 4 via the network 10. The users may establish accounts on the server 2 and store digital contents in his or her account, making it easy to manage digital contents for printing and other purposes.

The server 2 will allow a user to search for and obtain works in the servers of the copyright management center 6. The search may be by author, title, keywords, etc. The server 2 typically receives a search query from the user 4, and performs the searches in one or more copyright management center servers 6 on behalf of the user. This functionality also allows the user to obtain or acquire (e.g. through a purchase) desired works from the copyright management center 6 with a specific permission to use the copyrighted works. The server 2 may further interact with the print shop server 8 to submit a compiled file for printing.

In this application, the term “copyright management center” generally refers to a place or service that facilitates the management and distribution of copyrighted materials and the calculating, obtaining and transferring of payment to copyright holders. Typically, a copyright management center facilitates legitimate access to copyrighted content by providing a copyright registry, where users can locate copyright information about a work, by also providing a copyright marketplace exchange, where users can buy and sell copyrights, and by further providing a copyright clearance service that can connect with third party distribution platforms. Examples of such copyright management centers may include digital repository of published work maintained by some publishers or digital libraries maintained by various organizations. Another example of copyright management center is the Copyright Clearance Center. Therefore, “copyright management center 6” of the system shown in FIG. 1 may generally include any types of sources of digital contents and their copyright data and license information.

The physical locations or the commercial relationship among the various components of the system of FIG. 1 are not important. For example, the server 2 may be operated by the copyright management center, or the print shop, or a separate institution, organization or commercial establishment.

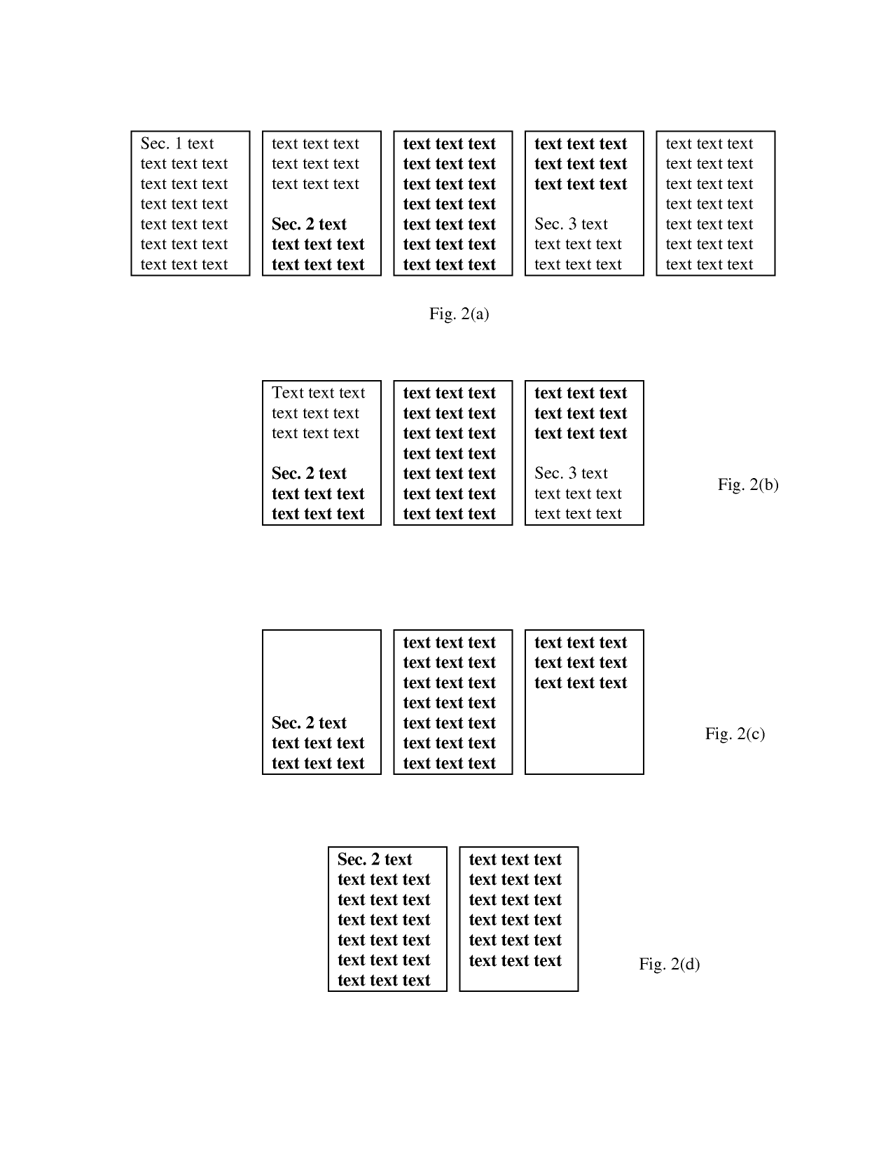

FIGS. 2(a) through 2(d) illustrate a process of content extraction in reproducing copyrighted works according to an embodiment of the present invention.

Referring to FIG. 2(a), there is illustrated an example of a copyrighted work. In this example, the copyrighted work is a 5-page article. Traditionally copyright fee payment is calculated based the whole article. Assuming the user only wants to reproduce Section 2 of the article, which spreads on only pages 2-4 of the article. The embodiments of the present invention will allow the user to extract pages 2-4 of the article for reproduction, as shown in FIG. 2(b), and calculate copyright fees based on the use of pages 2-4 only, not the whole article, so that the copyright fees to be paid by the user may be reduced. The server 2 may provide a user graphic interface (GUI) to allow a user to select the sections or portions of the article that the user desires to reproduce, and extract the pages that contained the user selected sections or portions.

Sometimes the extracted pages are in a format that does not allow additional formatting. In such cases the pages will be reproduced in the original layout as they have been extracted, as shown in FIG. 2(b). In cases where the extracted pages are in a format that allows some format or layout manipulating steps, for example redaction, then it may be preferable to redact the unselected contents from the extracted pages, as shown in FIG. 2(c). In cases where the extracted pages are in a format that allow further formatting, such as the layout of the texts or contents on the pages may be relocated, then it may be preferable to remove the unselected contents from the extracted pages, and relocated the selected contents on the extracted pages so that there is no wasted blank spaces. This may result in the reduction of the number of pages needed to reproduce the selected contents, as shown in FIG. 2(d).

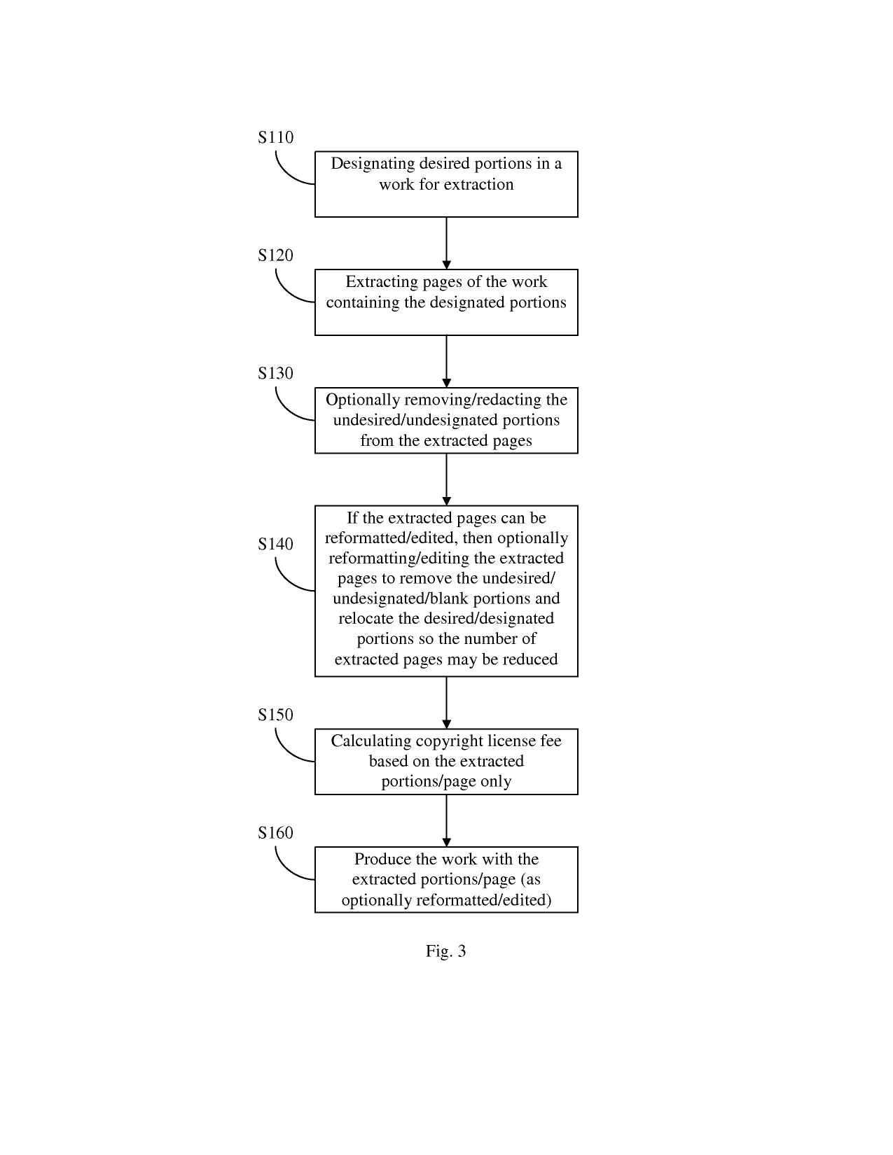

Referring to FIG. 3, there are illustrated the general steps of a method implemented, for example, in the server 2 in accordance with the embodiments of the prevent invention. As mentioned earlier, a GUI may be provided by server 2 to allow the user 4 to interact with the server program to perform various steps of the process described below.

In Step 110, a user reviews or otherwise examines the contents of a work to be reproduced, and designate desired portions in the work for extraction. The user may designate desired or needed sections or portions of the contents, or pages of the work, for extraction from the work. FIG. 2(a) illustrates an example of a 5-page article where the user desired section is section 2 appearing on pages 2-4 of the article.

In Step 120, the pages of the work containing the designated sections, portions or pages as designated by the user are extracted from the entire work into a digital or electronic file such as a PDF file. FIG. 2(a) illustrates the example shown in FIG. 2(a) after extraction, where pages 2-4 of the article containing the user desired section 2 are extracted from the 5-page article. This will allow the calculation of the copyright fees payment based not on the entire 5-page article, but rather only on the 3 extracted pages, resulting in potential saving in copyright license costs.

In Step 130, the undesired/undesignated sections or portions on the extracted pages in the digital file may be optionally removed. This may be accomplished in a number of ways, depending on the digital format of the article. For example, if the article is in PDF format, the undesired/undesignated sections or portions on the extracted pages may be redacted. FIG. 2(c) illustrates the example shown in FIG. 2(b) after redaction. This may result in further reduction of copyright fee payment. For example, after this Step 130 the number of words left on the extracted pages with redaction as shown in FIG. 2(c) is less than the number of words left on the extracted pages without redaction as shown in FIG. 2(b). If the copyright fee calculation is based on the number of words used in the reproduction, then this Step 130 may further reduce the copyright license fee payment.

In Step 140, if the format of the digital file allows further reformatting or editing, or may be converted into a format (such as PDF, JPEG or TXT format) that allows further reformatting or editing, then the embodiments of the present invention may optionally endeavor to further reformat or edit the extracted pages to remove the undesired, undesignated or blank portions, and relocating or remapping the desired or designated portions on the extracted pages, so the number of extracted pages may be reduced. For example, after this Step 140 the number of extracted pages with text/contents relocation/remapping as shown in FIG. 2(d) is less than the number of extracted pages without such editing as shown in FIGS. 2(b) and 2(c). If the copyright fee calculation is based on the number of pages in the reproduction, then this Step 140 may result in further reduction of copyright cost.

In Step 150, the copyright license fee is calculated based on the extracted portions/pages only. As seen in the examples shown in FIGS. 2(a) through 2(d), if the copyright fee may be calculated based on the number of pages reproduced, then reproducing the user desired or designated contents as shown in FIG. 2(b) may result in a copyright fee payment for 3 pages only instead of 5 pages as shown in FIG. 2(a), and reproducing the 2 reformatted/edited pages as shown in FIG. 2(d) may result in a copyright fee payment less than that for the 3 unformatted/unedited pages as shown in FIG. 2(b). Likewise, if the copyright fee may be calculated based on the number of words reproduced, then reproducing the user desired or designated contents as shown in FIG. 2(c) after redaction may result in a copyright fee payment less than that for the unredacted pages as shown in FIG. 2(b). In these examples, a quantitative basis, for example the number of pages or words, for calculating copyright fees is changed so the copyright fee may be reduced. This quantitative basis may be used at least in part (among possibly many other factors) as a basis for calculating copyright fees. In other words, this Step 150 is for editing the extracted portions if a format of the digital file allows for such editing to change a quantitative basis for calculating copyright fees for reproducing the desired contents of the copyrighted work.

In Step 160, the user needed or desired contents, sections, portions or pages of the copyrighted work are reproduced on the extracted page as optionally reformatted/edited in either electronic form as a digital file or printed form as a hard copy document. As described above, copyright fee payment for such reproduction may be reduced as only the user needed or desired contents of the copyrighted work are reproduced.

The above described process may be implemented by a computer software program. The present invention also provides a computer program product that includes a computer usable non-transitory medium (e.g. memory or storage device) having a computer readable program code embedded therein for controlling a data processing apparatus, the computer readable program code configured to cause the data processing apparatus to execute the above described process.

The above described exemplary embodiments of the present invention provide users with useful approaches and options to reproduce copyrighted works with reduced royalty payment. The users of copyrighted works can legitimately use such works to their own individualized selection of the contents to be compiled into a volume or booklet for POD printing or digital distribution while reducing the cost of obtaining copyright licenses because they will not need to pay for the unused contents of the works.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

What is claimed is:

1. A method for reproducing copyrighted works with contents extraction to reduce copyright costs, comprising the steps of:
designating contents of a copyrighted work desired to be reproduced;
extracting into a digital file portions of the copyrighted work containing the designated contents;
editing the extracted portions if a format of the digital file allows for such editing to change a quantitative basis for calculating copyright fees for reproducing the desired contents of the copyrighted work; and
calculating copyright fees for reproducing the desired contents of the copyrighted work based at least in part on the changed quantitative basis.

2. The method of claim 1, further comprising step of converting the format of the digital file into a format that may be edited.

3. The method of claim 1, further comprising step of converting the format of the digital file into a format that may be reformatted.

4. The method of claim 1, wherein the step of editing the extracted portions comprises the step of removing undesired contents from extracted portions.

5. The method of claim 1, wherein the step of editing the extracted portions comprises the step of redacting undesired contents from extracted portions.

6. The method of claim 1, wherein the step of editing the extracted portions comprises the step of relocating the desired contents of the extracted portions to remove one or more blank spaces.

7. The method of claim 1, wherein the step of editing the extracted portions comprises the step of reformatting the desired contents of the extracted portions to remove one or more blank spaces.

8. The method of claim 1, wherein the quantitative basis for calculating copyright fees for reproducing the desired contents of the copyrighted work is a number of pages of the digital file of the extracted portions of the copyrighted work.

9. The method of claim 1, wherein the quantitative basis for calculating copyright fees for reproducing the desired contents of the copyrighted work is a number of words in the digital file of the extracted portions of the copyrighted work.

10. The method of claim 1, further comprising the step of reproducing the desired contents of the copyrighted work.

11. A computer program product comprising a non-transitory computer usable medium having a computer readable code embodied therein for controlling a data processing apparatus, the computer readable program code configured to cause the data processing apparatus to execute a process for reproducing copyrighted works with contents extraction to reduce copyright costs, the process comprising the steps of:
designating contents of a copyrighted work desired to be reproduced;
extracting into a digital file portions of the copyrighted work containing the designated contents;
editing the extracted portions if a format of the digital file allows for such editing to change a quantitative basis for calculating copyright fees for reproducing the desired contents of the copyrighted work; and
calculating copyright fees for reproducing the desired contents of the copyrighted work based at least in part on the changed quantitative basis.

12. The computer program product of claim 11, wherein the process further comprises the step of converting the format of the digital file into a format that may be edited.

13. The computer program product of claim 11, wherein the process further comprises the step of converting the format of the digital file into a format that may be reformatted.

14. The computer program product of claim 11, wherein the step of editing the extracted portions comprises the step of removing undesired contents from extracted portions.

15. The computer program product of claim 11, wherein the step of editing the extracted portions comprises the step of redacting undesired contents from extracted portions.

16. The computer program product of claim 11, wherein the step of editing the extracted portions comprises the step of relocating the desired contents of the extracted portions to remove one or more blank spaces.

17. The computer program product of claim 11, wherein the step of editing the extracted portions comprises the step of reformatting the desired contents of the extracted portions to remove one or more blank spaces.

18. The computer program product of claim 11, wherein the quantitative basis for calculating copyright fees for reproducing the desired contents of the copyrighted work is a number of pages of the digital file of the extracted portions of the copyrighted work.

19. The computer program product of claim 11, wherein the quantitative basis for calculating copyright fees for reproducing the desired contents of the copyrighted work is a number of words in the digital file of the extracted portions of the copyrighted work.

20. The computer program product of claim 11, wherein the process further comprises the step of reproducing the desired contents of the copyrighted work.
